(19) United States
(12) Patent Application Publication
(10) Pub. No.: US 2025/0371163 A1
(43) Pub. Date: Dec. 4, 2025

(54) SYSTEMS AND METHODS FOR PERFORMING IN-MEMORY SECURITY ANALYTICS

(71) Applicant: Google LLC, Mountain View, CA (US)

(72) Inventors: Travis Lanham, Sunnyvale, CA (US); David Slater, New York, NY (US); Mike Hom, Arlington, VA (US); Sunkyu Lim, Mountain View, CA (US); David Burl, Sunnyvale, CA (US)

(21) Appl. No.: 19/220,732

(22) Filed: May 28, 2025

Related U.S. Application Data
(60) Provisional application No. 63/654,606, filed on May 31, 2024.

(51) Int. Cl. G06F 21/57; G06F 21/54; G06F 21/55

(52) U.S. Cl. CPC G06F 21/577; G06F 21/54; G06F 21/552

(57) ABSTRACT

A method includes receiving, by a processing device of a security analytics platform, data associated with a computing resource and assigning a first subset of a set of security rules to a first node of the security analytics platform and a second subset of the set of security rules to a second node of the security analytics platform. The first node applies, to the data, the first subset of security rules to generate first analytics data and the second node applies, to the data, the second subset of security rules to generate second analytics data. The first analytics data and the second analytics data are sent to a system associated with the computing resource.

### RELATED APPLICATION

This application claims the benefit of U.S. Provisional Application No. 63/654,606, filed May 31, 2024, the entire content of which is hereby incorporated by reference.

### TECHNICAL FIELD

Aspects and implementations of the present disclosure relate to computer security, and in particular to for performing in-memory security analytics.

### BACKGROUND

Computing devices such as data centers and cloud computing platforms can be susceptible to malicious activity (e.g., malware, network-based attacks). Malicious activity can lead to interruption or inefficient operation of computing devices, which can be problematic for owners and operators of computing devices. In extreme cases, malicious activity can damage computing devices or data stored thereon, potentially causing substantial financial loss and other losses and liabilities for the owners and operators of computing devices.

Security analytics platforms may have malicious activity notification mechanisms in place that alert clients when potential malicious activity is detected. The malicious activity can then be mitigated, e.g., by blocking a malicious file from being downloaded, stopping malicious processes that are running, etc.

### SUMMARY

The following presents a simplified summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a simplified form as a prelude to the more detailed description that is presented later.

An aspect of the disclosure provides a computer-implemented method which includes receiving, by a processing device of a security analytics platform, data associated with a computing resource and assigning a first subset of a set of security rules to a first node of the security analytics platform and a second subset of the set of security rules to a second node of the security analytics platform. The first node applies, to the data, the first subset of security rules to generate first analytics data and the second node applies, to the data, the second subset of security rules to generate second analytics data. The first analytics data and the second analytics data are sent to a system associated with the computing resource.

A further aspect of the disclosure provides a system comprising: a memory; and a processing device, coupled to the memory, the processing device to perform a method according to any aspect or implementation described herein.

A further aspect of the disclosure provides a non-transitory computer-readable medium comprising instructions that, responsive to execution by a processing device, cause the processing device to perform operations according to any aspect or implementation described herein.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example of system architecture, in accordance with implementations of the disclosure.

FIG. 2 depicts a block diagram illustrating example components of a security analytics platform, in accordance with implementations of the disclosure.

FIG. 3 depicts a flow diagram of an example method for performing security analytics using a security analytics platform, in accordance with implementations of the present disclosure.

FIG. 4 depicts a block diagram of an example computing device operating in accordance with one or more aspects of the present disclosure, in accordance with implementations of the present disclosure.

### DETAILED DESCRIPTION

A security analytics platform can ingest telemetry data from computing resources (e.g., computing systems) of a platform customer to detect and respond to security threats on those computing resources. The telemetry data can include log files produced by the operating systems, middleware, and/or applications that reflect actions which occurred at specific moments in time on a computing resource (referred to as “events”). The ingested telemetry data can be transformed prior to being analyzed for security threats. These transformations can include filtering the telemetry data (e.g., dropping data that is unrelated to certain services, dropping certain types of undesired data, etc.), modifying attributes (e.g., updating, inserting deleting, replacing existing attributes on metrics, trace data, etc.), renaming metrics or metric labels, enriching telemetry data with resource attributes, and so forth.

An analytics service can be employed to analyze the transformed telemetry data for security threats. The analytics service may implement a rule-based approach to detect security threats (e.g., malware, vulnerabilities, attacks, etc.). In particular, security rules define the logical conditions applied to the telemetry data, which, if satisfied, result in identifying event(s) of interest (e.g., potential security threats). For example, single-event rules apply a rule to a single piece of telemetry data from an event to determine whether the event is a potential security risk while multi-event rules apply the rule to multiple pieces of telemetry data to determine whether the event is a potential security risk.

Accordingly, an analytics service may receive event data, store the event data in an on-disk database, then run scheduled queries on the stored event data to perform security analytics. To run scheduled queries, the analytics service obtains a subset of the stored event data at predefined intervals, then applies a set of rules to the subset to search for security threats. As additional rules are added, latency and computational complexity for performing the analytics may significantly increase.

Aspects of the present disclosure relate to improved security analytics platforms. In particular, the aspects of the present disclosure enable a security analytics platform to run analytics on an input of event data as received from other services without persisting (i.e., storing) the event data to non-volatile memory (e.g., to a disk). In some implementations, the security analytics platform can maintain a set of nodes where each node can maintain, in-memory (e.g., in the volatile memory), a respective subset of security rules. For each set of input data received, each node receives a copy of the input data and employs a rule evaluator to apply its respective subset of security rules to the event data to perform a security analysis. The analytics data generated by each node can then be sent to a downstream system for further processing.

As the set of rules grows or the throughput of data increases, the security analytics platform can balance the workload of security analytics platform by adding additional nodes to perform the security analysis. Each node added can receive a subset of the security rules in-memory. The rules can be split, for example, based on one or more rules attributes. For example, a common characteristic of the condition the rule may be used to detect a security threat, such as, login-type rules, duration-based rules, etc. In another example, the rules can be split in view of the amount of memory required to apply each rule during the security analysis, randomly, via user input, or any combination thereof.

Aspects of the present disclosure result in improved performance of security analytics platforms. In particular, the aspects of the present disclosure use an in-memory rule evaluator to run security risk operations on the telemetry data. This results in a decreased latency of performing security analysis as opposed to running queries on an on-disk database. Further, aspects of the present disclosure increase nodes for parallel processing as the number of rules used increases. This allows the security analytics platform to process greater volumes of data without incurring latency costs Thus, considerable time and computing resources are saved.

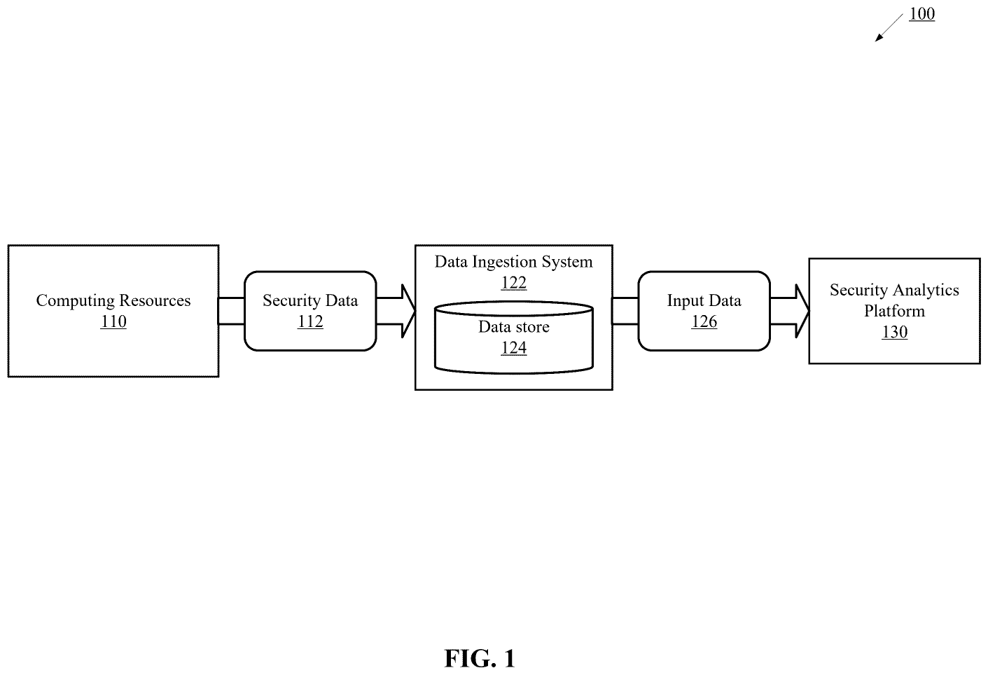

FIG. 1 illustrates an example system architecture 100 for performing in-memory security analytics, in accordance with implementations of the present disclosure. The system architecture 100 (also referred to as “system” herein) includes computing resources 110, data ingestion system 122, and security analytics platform 130. Computing resources 110 can provide various types of security data 112 to data ingestion system 122. Security data 112 can include telemetry data, contextual data, and/or change log data. Telemetry data can include log files produced by the operating systems, middleware, and/or applications that reflect metrics, measurements, events, etc. pertaining to computing resources 110 and/or corresponding software. Contextual data can include background data that gives a broader understanding of the telemetry data, such as, for example, network activity metadata, data related to current and/or past threats, data related to file hashes, data related to domains, and other data related to the customer's organization. Change log data can include upgrades, downgrades, enhancements, bug fixes, modifications, deprecations, etc. related to the telemetry data, contextual data, computing resources 110 and/or corresponding software. The data ingestion system 122 can include data store 124.

In some implementations, computing resources 110 includes a computing system operated by a user (e.g., a customer) of the entity that operates the security analytics platform 130 and provides security analytics services to the customer. In certain implementations, computing resources 110 can include multiple computing systems, each operated by one or more users. Computing resources 110 can include one or more servers. A server can include a computing device. In some implementations, a computing device includes a physical computing device or includes a virtualized component, such as a virtual machine (VM) or a container. A computing device can include an instance of a computing device. An instance of a computing device can include a spun-up instance that cannot be specific to any computing device. In some implementations, a VM can include a system virtual machine, which can include a VM that emulates an entire physical computing device. A VM can include a process virtual machine, which can include a VM that emulates an application or some other software. A container can include a computing environment that logically surrounds one or more software applications independently of other applications executing on the computing resources 110.

The computing resources 110 can include one or more network devices. A network device can include a switch, router, hub, gateway, wireless access point, bridge, modem, repeater, or another type of network device. A network device can help provide data communication between the one or more servers, between other devices of the computing resources 110, or between a computing device external to the computing resources 110 and a device of the computing resources 110. Computing resources 110 can include one or more data storage devices. A data storage device can include a data store. One or more servers or other computing devices of computing resources 110 can store data on the one or more data storage devices or retrieve data from the one or more data storage devices.

In some implementations, computing resources 110, data ingestion system 122, and the security analytics platform 130 are in data communication with each other over a data network. The data network can include a local area network (LAN), wide area network (WAN), a virtual private network (VPN), or some other data network. The data network can include network devices, including switches, routers, hubs, gateways, wireless access points, bridges, modems, repeaters, or other network devices.

In some implementations, computing resources 110, data ingestion system 122, and security analytics platform 130 can execute on different computing systems. In other implementations, at least a portion of computing resources 110, data ingestion system 122, and security analytics platform 130 can execute on the same computing system. The computing system can include a cloud computing system. A cloud computing system can include one or more computing devices (or portions of cloud computing devices) provided to an end user by a cloud provider. An end user of the environment can utilize a portion of the cloud computing system to host content for use or access by other parties or perform other computational tasks. In some implementations, the cloud computing system can be configured to allow the end user to use a portion of a computing device (e.g., only certain hardware, software, or other computer system resources). The cloud computing environment can include a private cloud, a public cloud, or a hybrid cloud. The cloud computing environment can provide infrastructure-as-a-service (IaaS), platform-as-a-service (PaaS), or software-as-a-service (SaaS) computing. The cloud computing environment can provide serverless computing.

In some implementations, security data 112 provided by the computing resources 110 includes one or more event logs reflecting telemetry data, contextual data, and/or change log data. An event log can include a data record that represents an event related to a device or software of the computing resources 110. A device (including a component of a device) can generate the event log, or software can generate the event log. The event log can include data about the event represented by the event log. In some implementations, an event log includes a structured event log. A structured event log can include event data in a structured format. Event data in a structured format can include data that is organized into a recognized format. The structured event log can include event data in a Javascript Object Notation (JSON) format, an Extensible Mark-up Language (XML) format, a comma-separated values (CSV) format, or event data in some other structured format.

In some implementation, the data ingestion system 122 includes software configured to obtain data 112 from the computing resources 110, convert at least a portion of the security data 112 to a standardized format used by data ingestion system 122 and/or security analytics platform 130, and store the data in the standardized format in the data store 124. Because different portions of the security data 112 can be in different formats, the data ingestion system 122 can convert the security data 112 into a standardized format used by the security analytics platform 130 so the platform 130 can efficiently analyze the converted security data 112.

In some implementations, data ingestion system 122 can send input data 126 to security analytics platform. Input data 126 refers to multiple items of security data sent that are grouped and collectively exported (e.g., to security analytics platform 130) from data ingestion system 122. In some implementations, the input data 126 can include raw data (original data received from computing resources 110), modified data (any security data that is converted, formatted, altered, enriched, etc. by data ingestion system 122 or any other external system or service), particular types of data (e.g., telemetry data, contextual data, change log data, etc.) or any combination thereof. The size and/or contents of input data 126 can be determined by the customer, the capabilities of security analytics platform 130 and/or data ingestion system 122, etc.

In some implementations, the data ingestion subsystem 122 can perform one or more data enrichment operations to generate or modify security data 112. For example, data ingestion system 122 can convert security data 112 from the computing resources 110 into a key-value pair (format used for data storage, discussed below), and data ingestion system 122 can then enrich security data 112 by adding, for example, relevant platform-provided data. The platform-provided data can include platform proprietary data, open-source data, other publicly available data, etc. In some implementations, data ingestion system 122 does not convert at least a portion of the security data 112 to a standardized format used by data ingestion system 122 and/or security analytics platform 130 and can use the portion of the security data 112, in its original format, as one or more key-value pairs. In some implementations, the data enrichment can be performed by security analytics system 126.

The standardized format for storing data in data store 124 can include one or more key-value pairs. A key can include data that indicates a category of data, and the corresponding value can include data that belongs to that category. More specifically, a key can refer to an attribute or a set of attributes used to identify a row (or tuple) uniquely in a table (or relation). The key can be used to establish relationships between the different columns, rows, and/or tables of a data store 124. Keys can include primary keys (used to uniquely identify each record in a table), candidate keys (alternative unique keys that could be used as primary keys), super keys (a collection of keys used to recognize every row in the table), foreign keys (used to establishes a relationship between tables), alternate keys (a key that has the potential to replace the primary key but is not yet the primary key), compound keys (a set of combined attributes used as a single key), surrogate keys (artificial keys assigned for record identification) and so forth. The value can be any user data, such as, for example, telemetry data, contextual data, change log data, modified data (any ingested data that is converted, formatted, altered, enriched, etc.), etc.

In some implementations, the data ingestion system 122 can store one or more key-value pairs in the data storage 124. Data store 124 can include a physical storage medium that can include volatile storage (e.g., random access memory (RAM), etc.) or non-volatile storage (e.g., a hard disk drive (HDD), flash memory, etc.). Data store 124 can include a file system, a database (an object-oriented database, a relational database, a distributed database, etc.), or some other software configured to store data.

Security analytics system 130 can include one or more computing devices (such as a rackmount server, a router computer, a server computer, a personal computer, a mainframe computer, a laptop computer, a tablet computer, a desktop computer, etc.), data structures (e.g., hard disks, memories, databases), networks, software components, or hardware components that can be used to provide a user with access to data or services. Such computing devices can be positioned in a single location or can be distributed among many different geographical locations. For example, security analytics system 130 can include a plurality of computing devices that together may comprise a hosted computing resource, a grid computing resource, or any other distributed computing arrangement. In some implementations, security analytics system 130 can correspond to an elastic computing resource where the allotted capacity of processing, network, storage, or other computing-related resources may vary over time.

Security analytics system 130 can be configured to collect, analyze, and respond to security data retrieved (or received) from data ingestion system 122 (e.g., input data 126). For example, security analytics system 130 can obtain the security data from data store 124 (e.g., collect event logs reflecting telemetry data). Security analytics system 130 can then provide computing resources 110 with tools to analyze the received data. In some implementations, one or more aspects of the tools to analyze the queried data can be automated or partially automated. Security analytics system 130 can provide computing resources 110 with tools to perform one or more actions based on information obtained from the queried data.

In some implementations, security analytics platform 130 can analyze the input data 126 using a rule-based approach. In particular, the rule-based approach can apply one or more security rules to a chosen one or more items of data (e.g., event data) in input data 126. A security rule can define a logical condition applied to the input data items and can further define an action to be performed responsive to determining that the logical condition is satisfied. The action can be, for example, sending an alert (to a downstream system or to a system related to the computing resource) that identifies an event of interest (e.g., a potential security threat), providing the data item(s) that triggered the detection and associated metadata (e.g., a description of the detected threat) to a downstream system for further analysis and processing and/or to a data visualization user interface (referred to as “dashboarding”), generating an entry in a Security Orchestration, Automation, and Response (SOAR) platform or in a ticketing system, etc. When one or more conditions in a rule (or one or more conditions of two or more rules) are satisfied, a security signal can be generated by security analytics platform 130, and presented to a user, trigger a corrective action, etc. The security rules can be applied to detect (or analyze the event data for) for anomalies, unusual patterns, identify data loss, identify malicious data, etc.

Security analytics platform 130 can apply the security rules to input data 126 upon receipt of the input data 126 from data ingestion system 122. In particular, security analytics platform 130 can store a set of security rules in-memory (e.g., load the set of rules onto the volatile memory of a node). Once input data 126 is received from data ingestion system 122, security analytics platform 130 can also load the input data in the volatile memory of the node, then apply the set of security rules to the input data to perform a security analysis. Once the analysis is performed, the results of the analysis can be sent to the user. It is noted that while input data 126 is used by way of illustrative example, other data types from other sources can provide input to security analytics platform 130. For example, security analytics platform 130 can receive raw or enriched data from one or more live data streams, historical data, etc. In some implementations, security analytics platform 130 can process the data received from the streams as received, or batch the data locally.

To balance the workload of security analytics platform 130, as the set of rules grows or the throughput of data increases, security analytics platform 130 can add new nodes to perform the security analysis. In particular, each node added can receive a respective subset of the security rules (which are loaded onto the respective volatile memory of each node). In an illustrative example, balancing the workload may involve balancing the projected processor usage and/or memory usage among the nodes, such that the maximum, among all pairs of nodes, difference in the projected processor usage and/or memory usage by a pair of nodes would not exceed a predefined difference threshold. When security analytics platform 130 receives input data 126, the input data 126 can be sent to each node, where each node applies their respective set of security rules to the input data 126. This allows security analytics platform 130 to process greater volumes of data without incurring latency costs.

In some implementations of the disclosure, a “user” can be represented as a single individual. However, other implementations of the disclosure encompass a “user” being an entity controlled by a set of users or an organization and/or an automated source such as a system or a platform. In situations in which the systems discussed here collect personal information about users, or can make use of personal information, the users can be provided with an opportunity to control whether the security analytics platform 120 collects user information (e.g., information about a user's social network, social actions or activities, profession, a user's preferences, or a user's current location), or to control whether and/or how to receive content from the security analytics platform 120 that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the security analytics platform 120.

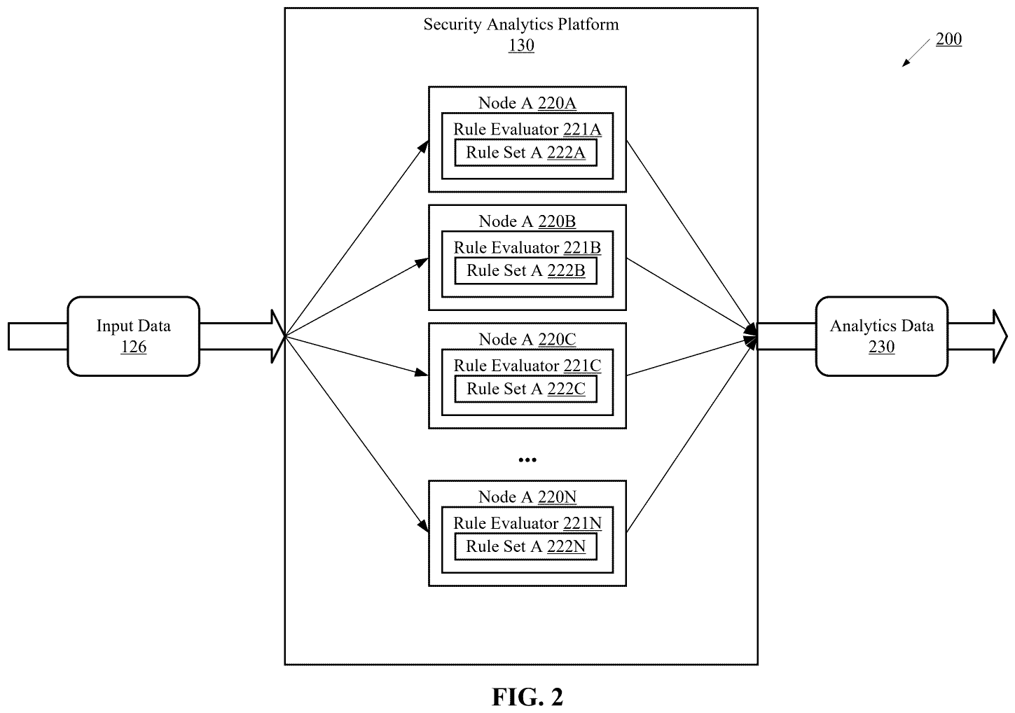

FIG. 2 depicts a block diagram of system 200 which illustrates example components of security analytics platform 130, in accordance with implementations of the present disclosure. System 200 includes security analytics platform 130. As discussed in FIG. 1, security analytics platform 130 can be configured to receive input data 126.

Security analytics platform 130 include a set of nodes 220A-220N. Each node includes a respective rule evaluator 221A-221N, where each rule evaluator 221A-221N includes a respective set of security rules (e.g., rule set A 222A-rule set N 222N). Each set of security rules 222A-222N can be loaded onto the volatile memory of its corresponding node 220A-220N. Each rule evaluator 221A-221N can be configured to apply its respective set of rules to the received input data 126 to generate analytics data 230. Analytics data 230 can include data indicative of whether the input data 126 contains one or more identified security threats (e.g., anomalies, unusual patterns, data loss, malicious data, etc.) or is clean (e.g., contains no identified security threats). In some implementations, each rule set can include a different set of security rules (e.g., security rules do not overlap between nodes). Alternatively, one or more security rules can overlap between two or more sets of security rules (e.g., at least one security rule is part of two or more security rules sets).

In some implementations, security analytics platform 130 can initially initiate a single node with a single rule set to process input data 126. As the number of rules increases, security analytics platform 130 can add one or more of nodes 220A-220N to balance its workload. In instances where the number of rules is decreased, security analytics platform 130 can remove one or more nodes 220A-220N. In some implementations, the number of nodes 220A-220N used by security analytics platform 130 can be modified in view of the number of rules to be applied during the security analysis, the processing load of each node, the amount of security data (e.g., input data 126) received by security analytics, etc. In an illustrative example, security analytics platform 130 can track the number of rules used for performing the security analysis. If the number of rules is greater than a certain threshold criterion (e.g., a threshold value), security analytics platform 130 can add another node and split the set of security rules between the current nodes. For example, if the threshold criterion is reflected in the value “x”, and the number of security rules is greater than the value x, then security analytics platform 130 can add another node, and split the rules between both nodes.

In some implementations, security analytics platform 130 can split the security rules in view of one or more rules attributes, randomly, or any combination thereof. A rule attribute can include any characteristic of the values of interest that the rule is using to detect a security threat. For example, these values can be related to login events, duration data, etc. Security analytics platform 130 can split the security rules based on these rules attributes by assigning two or more rules with the same attribute to the same rule set. In some implementations, security analytics platform 130 can split the rules in view of the amount of memory required to apply each rule during the security analysis. For example, one security rule can require twice as much memory, processing power and/or time to be applied as another security rule. As such, security analytics platform 130 can split the rules such that, for example, each node is assigned a set of rules that require a similar amount of memory, processing power, application time, etc. In some implementations, security analytics platform 130 can split rules in view of user input (e.g., the user can instruct security analytics platform 130 which rules are to be maintained by which rules set).

Each node 220A-220N can receive the input data 126 in parallel (e.g., each node receives the data simultaneously), in series (e.g., one node receives the data and forwards the data to another node once said node finished its security analysis), or any combination thereof (e.g., nodes can receive the data two at a time). Each node 220A-220N (via respective rule evaluators 221A-221N) can apply its respective rule set to the received data and apply the rules of its rule set to perform a security analysis. Once the analysis is complete, security analytics platform 130 can then export (e.g., send to the user) the results of the analysis (e.g., analytics data 230). Each node (or one or more nodes) can then receive another set of input data for analysis. As such, it is not necessary for security analytics platform 130 to store the input data 126 or the analytics data 230 to disk (e.g., to non-volatile memory).

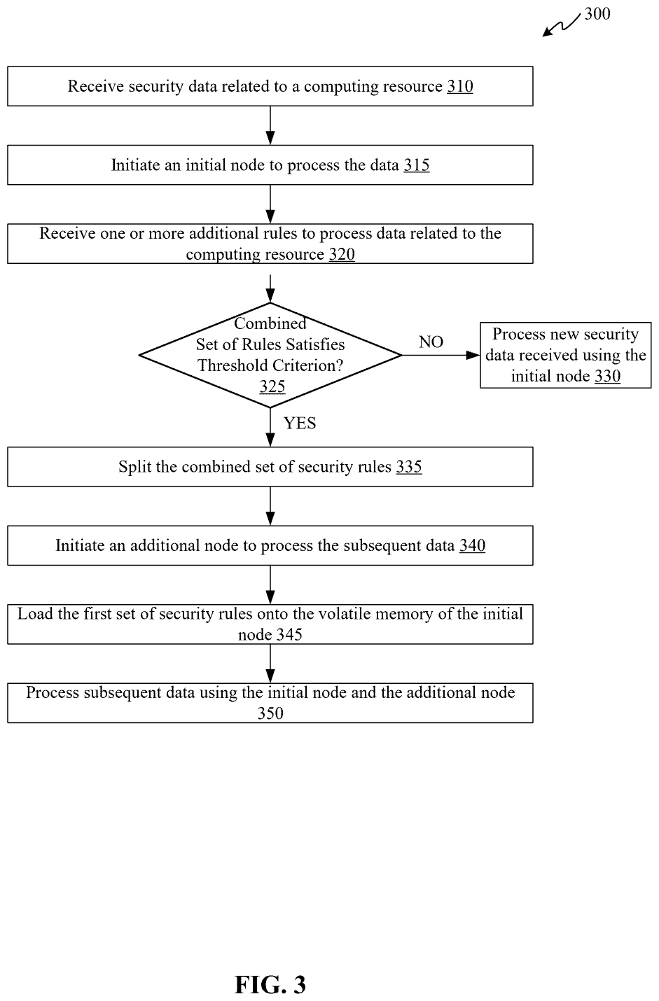

FIG. 3 depicts a flow diagram of an example method 300 for performing security analytics using security analytics platform 130, in accordance with implementations of the present disclosure. Method 300 can be performed by processing logic that can include hardware (circuitry, dedicated logic, etc.), software (e.g., instructions run on a processing device), or a combination thereof. In one implementation, some or all of the operations of method 300 can be performed by one or more components of system 100 of FIG. 1. In some implementations, some or all of the operations of method 300 can be performed by security analytics platform 130, as described above.

For simplicity of explanation, method 300, as well as any other method of this disclosure, is depicted and described as a series of acts. However, acts in accordance with this disclosure can occur in various orders and/or concurrently, and with other acts not presented and described herein. Furthermore, not all illustrated acts may be required to implement method 300 in accordance with the disclosed subject matter. In addition, those skilled in the art will understand and appreciate that method 300 could alternatively be represented as a series of interrelated states via a state diagram or events. Additionally, it should be appreciated that method 300 disclosed in this specification is capable of being stored on an article of manufacture (e.g., a computer program accessible from any computer-readable device or storage media) to facilitate transporting and transferring such method to computing devices. The term “article of manufacture,” as used herein, is intended to encompass a computer program accessible from any computer-readable device or storage media.

At operation 310, processing logic receives security data related to a computing resource. The security data can be received as part of a data batch or a data stream. The security data can include one or more of telemetry data, context data, change log data, etc. The security data can be received from data ingestion system 122, from one or more data pipelines, etc. In some implementations, the security data can include one or more indicators of which computing resource the security data is related to (e.g., key data, ID data, etc.). Once received, the security data can be loaded or stored on the volatile memory of, for example, security analytics platform 130 or a node of security analytics platform 130.

At operation 315, processing logic initiates an initial node to process the data. To initiate the initial node, the processing logic can boot a rules evaluator and load an initial set of security rules onto the volatile memory of the initial node. The processing logic can then process the data (e.g., apply the security rules to the data to generate analytics data) and export the analytics data (e.g., send the analytics data to the customer, send the analytics data to a downstream platform, etc.).

At operation 320, processing logic can receive one or more additional rules to process data related to the computing resource. The additional rules can be introduced by the computing resources, by the security analytics platform 130, etc.

At operation 325, processing logic determines whether the combined set of security rules (e.g., the initial set of rules and the one or more additional rules) satisfies a threshold criterion. In some implementations, the threshold criterion be be the number of rules exceeding a threshold value, a processing load of the initial node exceeding a threshold value, etc. Responsive to the processing logic determining that the combined set of security rules fails to satisfy the threshold criterion, the processing logic proceeds to operation 330, and processes any new security data received using the initial node. Responsive to the processing logic determining that the combined set of security rules satisfies the threshold criterion, the processing logic proceeds to operation 335.

At operation 335, processing logic splits the combined set of security rules. For example, processing logic can generate a first subset of security rules from the set of security rules and a second subset of security rules from the set of security rules.

At operation 340, processing logic initiates an additional node to process subsequent data. To initiate the additional node, the processing logic can boot a rules evaluator and load a second set of security rules onto the volatile memory of the additional node.

At operation 345, processing logic loads the first set of security rules onto the volatile memory of the initial node.

At operation 350, processing logic processes subsequent data using the initial node and the additional node. For example, the processing logic can apply the first subset of security rules to the data to generate a first set of analytics data and apply the second subset of security rules to the data to generate a second set of analytics data. The analytics can then be exported (e.g., sent to the customer, sent to a downstream platform, etc.). It is noted that as the input data flows through the security analytics platform, it may remain in-memory (on one or more volatile memory device of security analytics platform 130) without being persisted to any non-volatile memory of security analytics platform 130.

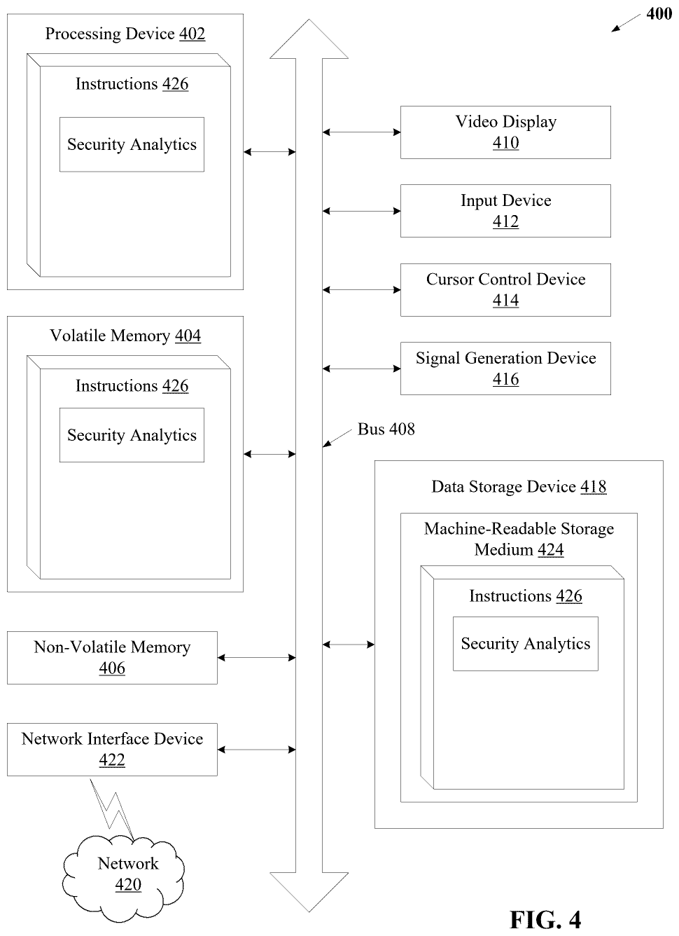

FIG. 4 depicts a block diagram of a computer system operating in accordance with one or more aspects of the present disclosure. In certain implementations, computer system 400 can be connected (e.g., via a network, such as a Local Area Network (LAN), an intranet, an extranet, or the Internet) to other computer systems. Computer system 400 can operate in the capacity of a client device. Computer system 400 can operate in the capacity of a server or a client computer in a client-server environment. Computer system 400 can be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 400 can include a processing device 402, a volatile memory 404 (e.g., random access memory (RAM)), a non-volatile memory 406 (e.g., read-only memory (ROM) or electrically erasable programmable ROM (EEPROM)), and a data storage device 418, which can communicate with each other via a bus 408.

Processing device 402 can be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 400 can further include a network interface device 422. Computer system 400 also can include a video display unit 410 (e.g., an LCD), an input device 412 (e.g., a keyboard, an alphanumeric keyboard, a motion sensing input device, touch screen), a cursor control device 414 (e.g., a mouse), and a signal generation device 416.

Data storage device 418 can include a non-transitory machine-readable storage medium 424 on which can store instructions 426 (e.g., security analysis instructions, security rules splitting instructions, etc.) encoding any one or more of the methods or functions described herein, including instructions encoding components of client device of FIG. 1 for implementing methods 300 and 400.

Instructions 426 can also reside, completely or partially, within volatile memory 404 and/or within processing device 402 during execution thereof by computer system 400, hence, volatile memory 404 and processing device 402 can also constitute machine-readable storage media.

While machine-readable storage medium 424 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein can be implemented by discrete hardware components or can be integrated in the functionality of other hardware components such as ASICS, FPGAs, DSPs or similar devices. In addition, the methods, components, and features can be implemented by firmware modules or functional circuitry within hardware devices. Further, the methods, components, and features can be implemented in any combination of hardware devices and computer program components, or in computer programs.

Unless specifically stated otherwise, terms such as “receiving,” “determining,” “sending,” “displaying,” “identifying,” “selecting,” “excluding,” “creating,” “adding,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and cannot have an ordinal meaning according to their numerical designation.

Examples described herein also relate to an apparatus for performing the methods described herein. This apparatus can be specially constructed for performing the methods described herein, or it can comprise a general-purpose computer system selectively programmed by a computer program stored in the computer system. Such a computer program can be stored in a computer-readable tangible storage medium.

The methods and illustrative examples described herein are not inherently related to any particular computer or other apparatus. Various general-purpose systems can be used in accordance with the teachings described herein, or it can prove convenient to construct more specialized apparatus to perform method 300 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method, comprising:
receiving, by a processing device of a security analytics platform, data associated with a computing resource;
assigning a first subset of a set of security rules to a first node of the security analytics platform and a second subset of the set of security rules to a second node of the security analytics platform;
applying, to the data, by the first node, the first subset of security rules to generate first analytics data;
applying, to the data, by the second node, the second subset of security rules to generate second analytics data; and
sending the first analytics data and the second analytics data to a system associated with the computing resource.

2. The method of claim 1, wherein the data comprises telemetry data.

3. The method of claim 1, further comprising:
responsive to determining that the set of security rules satisfy a threshold criterion, initiating a third node to process the data.

4. The method of claim 1, wherein the threshold criterion is based on at least one of a total number of security rules or the processing load of the first node.

5. The method of claim 1, further comprising:
assigning two or more security rules to the first subset based on an attribute shared by the two or more security rules.

6. The method of claim 1, wherein the data is received and processed by volatile memory of first node without being stored to non-volatile memory.

7. The method of claim 1, wherein the security data is enriched with one or more of platform proprietary data, open-source data, or publicly available data.

8. The system, comprising
a volatile memory; and
a processing device, coupled to the volatile memory, configured to perform operations, comprising:
receiving data associated with a computing resource;
assigning a first subset of a set of security rules to a first node and a second subset of the set of security rules to a second node;
applying, to the data, by the first node, the first subset of security rules to generate first analytics data;
applying, to the data, by the second node, the second subset of security rules to generate second analytics data; and
sending the first analytics data and the second analytics data to a system associated with the computing resource.

9. The system of claim 8, wherein the first data comprises telemetry data.

10. The system of claim 8, wherein the threshold criterion is based on a total number of security rules.

11. The system of claim 8, wherein the threshold criterion is based on the processing load of the first node.

12. The system of claim 8, wherein the operations further comprise:
assigning two or more security rules to the first subset based on an attribute shared by the two or more security rules.

13. The system of claim 8, wherein the data is received and processed by the volatile memory of first node without being stored to non-volatile memory.

14. The system of claim 8, wherein the security data is enriched with one or more of platform proprietary data, open-source data, or publicly available data.

15. A non-transitory computer-readable medium comprising instructions that, responsive to execution by a processing device, cause the processing device to perform operations comprising:
receiving data associated with a computing resource;
assigning a first subset of a set of security rules to a first node and a second subset of the set of security rules to a second node;
applying, to the data, by the first node, the first subset of security rules to generate first analytics data;
applying, to the data, by the second node, the second subset of security rules to generate second analytics data; and
sending the first analytics data and the second analytics data to a system associated with the computing resource.

16. The non-transitory computer readable storage medium of claim 15, wherein the first data comprises telemetry data.

17. The non-transitory computer readable storage medium of claim 15, wherein the threshold criterion is based on a total number of security rules.

18. The non-transitory computer readable storage medium of claim 15, wherein the threshold criterion is based on the processing load of the first node.

19. The non-transitory computer readable storage medium of claim 15, wherein the operations further comprise:
assigning two or more security rules to the first subset based on an attribute shared by the two or more security rules.

20. The non-transitory computer readable storage medium of claim 15, wherein the data is received and processed by the volatile memory of first node without being stored to non-volatile memory.
